(19) United States
(12) Patent Application Publication
(10) Pub. No.: US 2008/0199319 A1
(43) Pub. Date: Aug. 21, 2008

(54) Water Pump Impeller

(75) Inventors: Elmar Mause, Emskirchen (DE); Patrick Jahnke, Nuernberg (DE); Thomas Traudt, Pegnitz (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/994,804

(22) PCT Filed: Jun. 17, 2006
(86) PCT No.: PCT/EP2006/005832

§ 371 Date: Feb. 14, 2008

(30) Foreign Application Priority Data
Jul. 6, 2005 (DE) 10 2005 031 589.5

(51) Int. Cl. F04D 29/22; B29C 65/00

(52) U.S. Cl. 416/185; 416/223 R; 29/889.6

(57) ABSTRACT

The invention refers to an impeller, consisting of plastic, which Is intended for a coolant pump of an internal combustion engine. The impeller, which has a multipart construction, comprises a back wall, which is connected in one piece to guide vanes and also to a hub, and also a separate molded disk which on the end face partially covers the guide vanes in the installed state. The components, the back wall and the molded disk are positionally fixed by means of a materially bonding connection.

### FIELD OF THE INVENTION

The object of the present invention is an impeller consisting of plastic, which is especially intended for a coolant pump of an internal combustion engine. The impeller, which is designed as an injection-molded part, comprises a back wall, or base, with a central hub via which the impeller is seated upon a shaft. On one end face, the back wall is provided in one piece with guide vanes. On the side facing away from the back wall, the guide vanes are covered in areas on the end face by a molded disk, as a result of which cavities are formed inside the impeller and are delimited by the individual guide vanes, or the back wall, and by the molded disk.

### BACKGROUND OF THE INVENTION

Impellers for coolant pumps of internal combustion engines are preferably produced from plastic for achieving an inexpensively producible and weight-optimized component. The impellers of these coolant pumps are preferably designed for an axial inflow of the coolant which in a deflected manner flows radially out of the impeller. For this purpose, the impeller is provided with a multiplicity of guide vanes which are designed in a curved manner in the radial or in the axial-radial direction and which are connected in one piece to the back wall of the impeller.

An impeller of the previously mentioned type of construction is known from DE 38 39 860 A1. For achieving a positive locking connection between the impeller and a drive shalt of the coolant pump, a central section of the impeller has an axially projecting connector which has a polygonal profile. In the installed state, the connector engages in a positive locking manner in an end-face socket of a separate screw or of the pump shaft. The cross section of the socket in this case corresponds to the cross section of the axially protecting connector. The impeller, which comprises a multiplicity of individual parts, disadvantageously requires an increased installation cost.

### OBJECT OF THE INVENTION

The object of the present invention is to create a cost-optimized impeller consisting of plastic, which has improved strength and requires a low installation cost.

### SUMMARY OF THE INVENTION

The object is achieved according to the invention by the features of the independent claims 1, 2 and 11.

The use of a thermoplastic, a syndiotactic polystyrol (PS-S-GF30), is common to the inventions. This inexpensive material can be ideally used for impellers of coolant pumps. In this case, this plastic has an enhanced resistance to all coolants which are used in internal combustion engines, combined with a low crack susceptibility. Furthermore, the thermoplastic according to the invention can be used over the entire temperature spectrum of the coolant in internal combustion engines. The previously mentioned positive material properties for the impeller consisting of syndiotactic polystyrol PS-S-CF30 according to the invention were achieved by means of a special compounding. The thermoplastic which is used according to the invention can be advantageously processed with existing molds, i.e. plastic injection molding devices, as a result of which the material changeover has no influence upon the production costs on account of new molding devices, or molding devices which are to be adapted, as the case may be. The material PS-S-GF30 advantageously prevents a mold corrosion which occurs with the previously used plastic, which necessitated a labor-intensive and cost-intensive mold coating.

The syndiotactic polystyrol which is used according to the invention has exceptional material properties. Thus, the very low moisture absorption capacity allows a technically simple processing. Furthermore, this material is characterized by a very low thermal expansion coefficient. In addition, PS-S-GF30, on account of the good flow properties, enables components to be produced in the injection molding process with thin wall thicknesses. The low-viscosity plastic with high melt flow rate requires a lower injection pressure compared with previously used plastics, as a result of which impellers consisting of PS-S-GF30 can be inexpensively produced on injection molding machines with lower locking force.

As a result of the low density of PS-S-GF30 (≦1.35 gram/cm³), a saving in material can be additionally achieved. For an impeller which is intended for coolant pumps of known internal combustion engines of private motor vehicles, a saving in weight of ≧24% can be advantageously achieved by the use of PS-S-GF30. AP impeller consisting of PS-S-GF30 is characterized by its dimensional stability, its low shape distortion properties, and also by a desired lower processing temperature than with previously used plastics.

By means of the substitution of the previously used material PPS-GF40 by the syndiotactic polystyrol which is used according to the invention, for producing impellers from plastic a cost reduction of the impeller advantageously results without disadvantageous influence on the strength, on the resistance to chemicals or on the service life of the impeller.

The invention as claimed in claim 1 refers to an impeller which comprises a plurality of components, wherein the individually separately produced components, especially the back wall inclusive of the hub, and the associated guide vanes, and also the molded disk, are joined together in a materially bonding manner.

Claim 2 refers to an invention with an impeller which is designed in one piece and has undercuts, in which impeller syndiotactic polystyrol PS-S-GF30 as thermoplastic is used as material. The material changeover according to the invention, even for one-piece impellers, advantageously requires no adaptation or alteration whatsoever of the slide molds or of the injection molding process which is used for the production.

The invention as claimed in claim 11 refers to a method which claims a production sequence and installation steps, according to which an impeller which is designed with a multiplicity of parts can be produced. The production of the multipart impeller is advantageously carried out in sequential steps. First, the components, the back wall inclusive of the hub, and the associated guide vanes on the one hand, and also the molded disk on the other hand, are produced in separate injection operations. An adhesive is applied at least to a contact zone in a joining region between axially projecting knobs or protrusions on the guide vanes of the back wall and corresponding recesses of the molded disk. For achieving a materially bonding connection, these components are then joined together and pressed for a short time. A central bore of the hub in the region of the back wall serves for accommodating a separate bush which is also fixed in a materially bonding manner by means of adhesive bonding.

Further advantageous developments of the invention are the subject of the dependent claims 3 to 10.

Adhesive bonding is preferably provided for achieving a materially bonding connection of all components for an impeller which is constructed in a multipart manner. Consequently, a larger manufacturing accuracy can be achieved compared with a previously used ultrasonic or UV welding process. With adhesive bonding, centering on the impeller can advantageously be dispensed with, since this centering is carried out inside the mold. Owing to the improved, closely tolerated finishing accuracy, an improved concentricity results by means of the adhesive bonding. In this way, even with impellers which are dimensioned larger in cross section, or for impellers which are intended for high speeds, an adequate running smoothness can be achieved without an additional balancing.

A preferred development of an impeller which comprises a plurality of individual parts provides that the guide vanes include partially projecting protrusions or knobs which correspond to the associated recesses of the molded disk. In the installed state, centering of the molded disk is carried out by means of the knobs engaging in the recesses in a positive locking manner, wherein adhesive bonding in contact zones between the knobs and the recesses connects these components.

Cyanoacrylate, epoxy or synthetic rubber is preferably provided according to the invention as suitable adhesive for achieving a materially bonding connection of the components, back wall and molded disk. For the adhesive bonding, adhesive is applied on or to at least one component in a joining region between the axially projecting knobs and the recesses of the molded disk, before the components are fitted into each other, combined with a time-limited pressing.

The impeller according to the invention additionally has a separate bush which is positioned in a central bore of the hub and therefore of the back wall. The cylindrical bush, which is produced from a metal material or from a plastic, in this case is also positionally fixed in the hub by means of adhesive bonding. In the installed state, the impeller is torsionally fixed, for example by means of a press fit between the bush and an impeller shaft.

Alternatively to a separate bush, the invention includes an impeller which is produced from a thermoplastic, the hub of which is directly fastened, i.e. without a separate bush, in a torsionally rigid manner by means of a press fit and/or by means of adhesive bonding on the shaft of the impeller.

The thermoplastic which is used according to the invention for the impeller of the coolant pump is beige in color. As a result, a noticeable difference is apparent between the impellers which were previously produced in a dark color from PPS, compared with the beige impeller according to the invention.

For an impeller which is designed in one piece, it makes sense to introduce the bush into the injection mold as an inserted part, which during the injection operation is enveloped by the plastic PS-S-CF30 of the Impeller, for achieving a torsionally rigid connection.

Furthermore, the invention includes an impeller, the guide vanes of which have a three-dimensional (3D) curvature.

Further features of the invention result from the subsequent description for the drawings, in which exemplary embodiments of the invention are shown.

### BRIEF DESCRIPTION OF THE DRAWINGS

In the drawing:

FIG. 1 shows in a perspective view the impeller according to the invention in combination with a shaft;

FIG. 2 shows the front view of an impeller according to the invention;

FIG. 3 shows the impeller according to FIG. 2 in a sectional view, along the line 3-3;

FIG. 4 shows in one view the back wall of the impeller according to the invention;

FIG. 5 shows a sectional view of the back wall according to FIG. 4, along the line 5-5;

FIG. 6 shows the molded disk of the impeller according to the invention in the front view;

FIG. 7 shows in a sectional view the molded disk according to FIG. 6, along the line 7-7;

FIG. 8 shows in a perspective view an impeller with 3D-curved vanes.

### DETAILED DESCRIPTION OF THE DRAWINGS

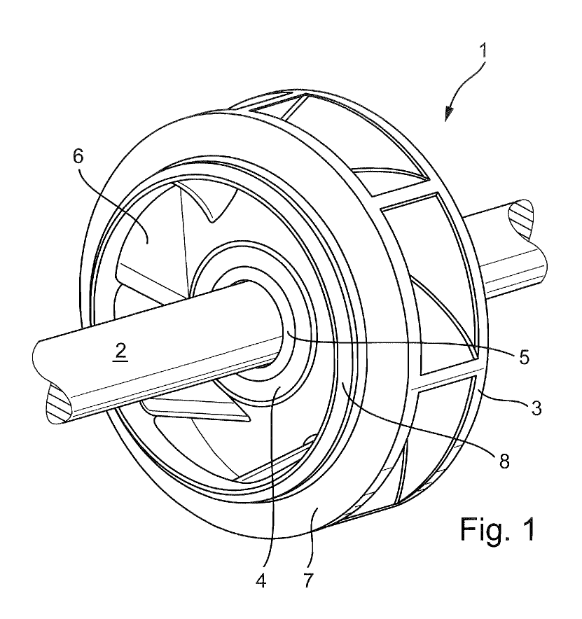

The construction of an impeller 1 according to the invention is displayed in FIG. 1. The impeller 1, which is positioned on a shaft 2 in a torsionally rigid manner, is intended for ensuring a circulation of coolant, especially cooling water, in the installed state. The construction of the impeller 1 comprises a back wall 3, which is also to be referred to as the base, and which centrally includes a hub 4. A bore 5 of the hub 4 serves for accommodating the shaft 2. The back wall 3, furthermore, is connected in one piece to guide vanes 6 which are formed in a radially or axially-radially curved manner, and which on the inner side extend radially from the region of the hub 4 to the outer contour of the back wall 3.

On the end face, the guide vanes 6 are covered by a molded disk 7 which, extending from the outer contour of the guide vanes 6, covers a limited end face region of the guide vanes. On the inner side, the molded disk 7 is provided in one piece with a neck 8 which is designed with a tubular form. In the operating state, the coolant is fed axially in the direction of the shaft 2 to the impeller 1 and is deflected inside the impeller 1, wherein the coolant diskharges radially from the impeller 1.

Drawings 2 and 3 illustrate further details of the impeller 1. The shape of the guide vanes 6 shows a locally drawn cutout in the molded disk 7. The molded disk 7, which is also to be referred to as an annular disk, largely extends over half the distance which is established between the outer contours of the hub 4 and the back wall 3. The inside diameter “dᵢ” of the neck 8 of the molded disk 7 determines the entry cross section for the coolant into the impeller 1. The impeller 1, which is constructed in a multipart manner, comprising the back wall 3, the molded disk 7, and also a bush 9a which is inserted in the bore 5 of the hub 4, are correspondingly produced from a thermoplastic (syndiotactic polystyrol, PS-S-GF30). On account of the good adhesive properties of this material, all individual parts of the impeller 1 are adhesively bonded to each other.

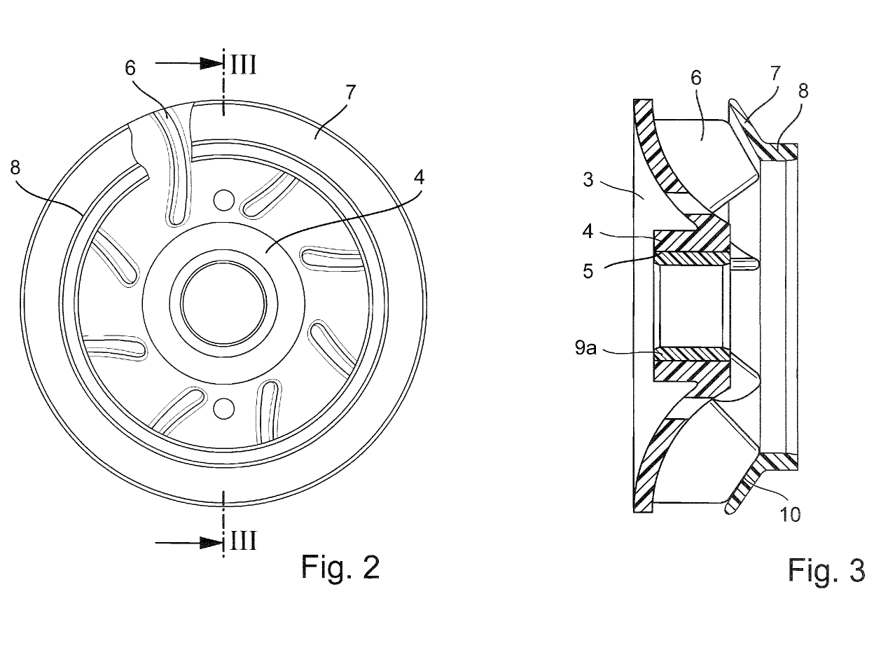

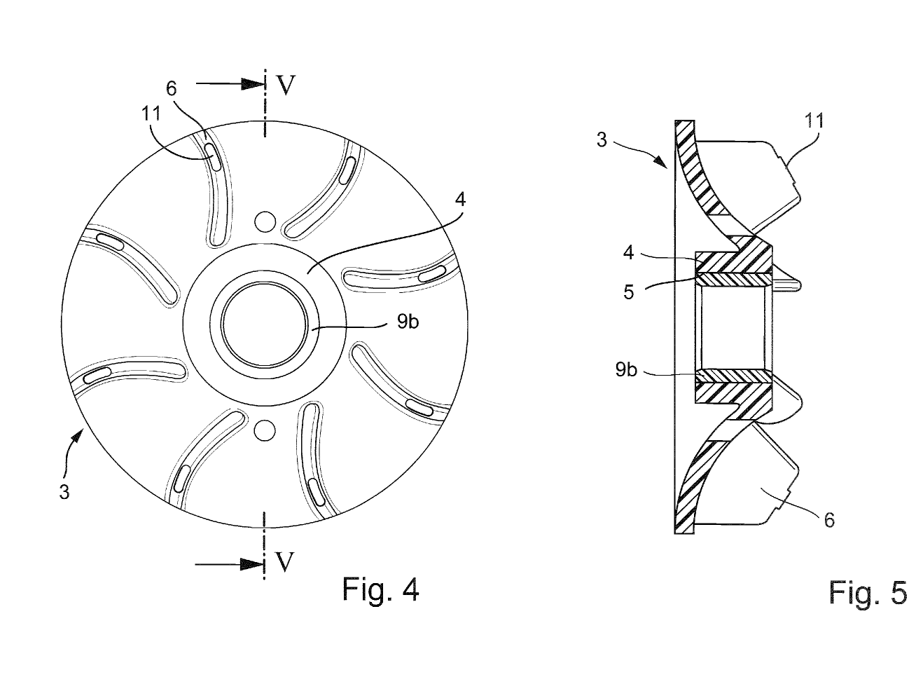

A first joining region 10 in this case is provided between the molded disk 7 and the guide vanes 6. In this case, a suitable adhesive is purposefully applied at least to a contact zone in the joining region 10 on the molded disk 7 or on the guide vanes 6, before these components are pressed at least for a short time until the adhesive bond is hardened. Alternatively, it would furthermore make sense to apply the adhesive to both contact zones in the joining region 10. Moreover, the bush 9a is durably fixed in the hub 4 by an adhesive bond. For this purpose, the generated surface of the bush 9a, or the bore 5 of the hub 4, is wetted with an adhesive before the bush 9a is inserted in the bore 5. The bush 9a preferably has a knurling on the outer side, as a result of which a positive locking, torsionally fixed fastening additionally results. In FIGS. 4 and 5, the back wall 3, which is connected in one piece to the guide vanes 6 and to the hub 4, is shown in two views. Alternatively to the bush 9a according to FIG. 3, the hub 4 according to FIG. 5 comprises a bush 9b which is produced from steel. For achieving a torsionally fixed installed position, the bush 9b is positioned in the hub 4 in a torsionally rigid manner by means of adhesive bonding or a press fit. FIG. 4 shows the shape of the guide vanes 6 and also their longitudinal extent and distribution on the back wall 3. According to FIG. 5, each guide vane 6 is provided in each case with a projecting knob or pin 11 on the obliquely oriented end face. All knobs 11 commonly form in the joining region 10 a contact zone which is associated with the guide vanes 6.

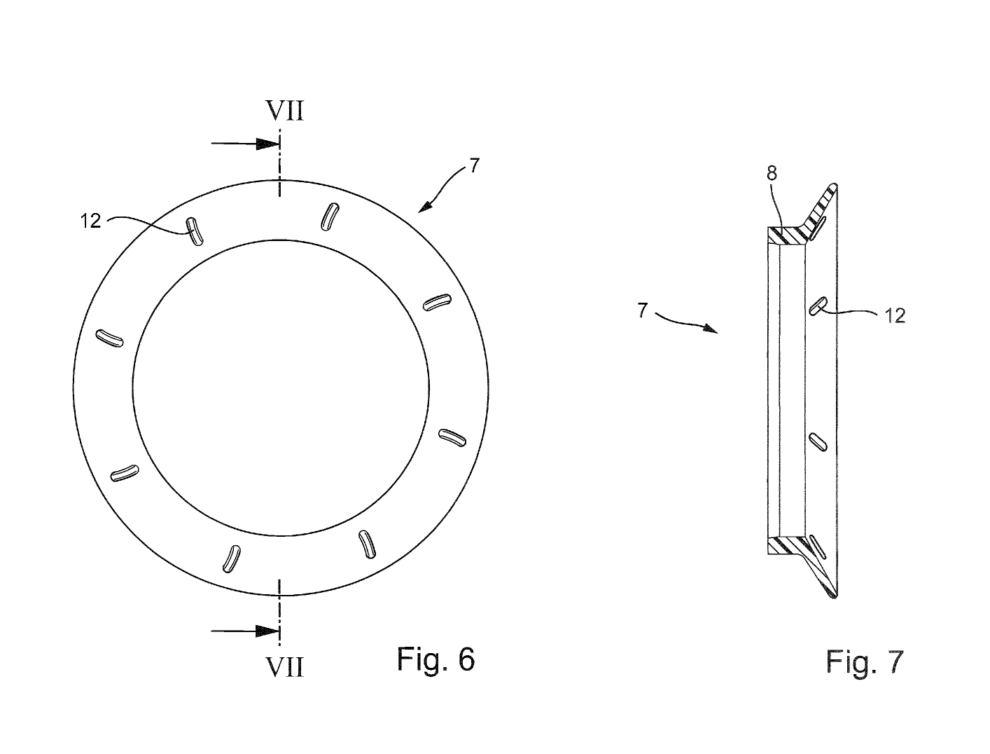

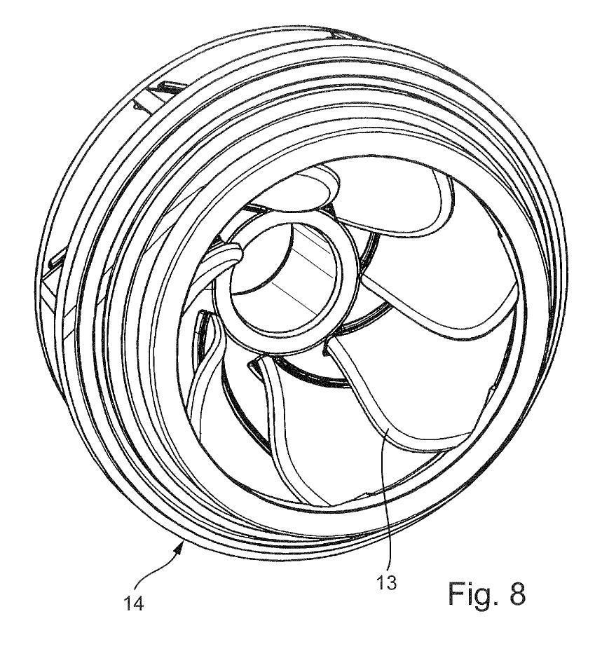

The arrangement, the position and also the design of the knobs 11, which correspond to conforming recesses 12 in the molded disk 7, is shown in FIGS. 6 and 7. The recesses 12 consequently form contact zones of the molded disk 7 in the joining region 10.

The impeller 14 according to FIG. 8 comprises guide vanes 13 which correspondingly have a three-dimensional (3D) curvature.

### LIST OF DESIGNATIONS

1 Impeller
2 Shaft
3 Back wall
4 Hub
5 Bore
6 Guide vane
7 Molded disk
8 Neck
9a Bush
9b Bush
10 Joining region
11 Knobs
12 Recess
13 Guide vane
14 Impeller

1. An impeller made of plastic, and intended for a coolant pump of an internal combustion engine, designed as an injection-molded part, comprising a hub, for seating upon a shaft, and a back wall which has guide vanes, wherein the guide vanes are covered on the end face by a molded disk, a multipart construction of the impeller, wherein its separately produced components, at least the back wall and the molded disk are joined together in a materially bonding manner, and syndiotactic polystyrol PS-S-GF30, a thermoplastic, is provided as material.

2. The impeller as claimed in claim 1, wherein with a one-piece construction which has undercuts, for production of which slide molds are used, wherein a thermoplastic, syndiotactic polystyrol PS-S-GF30, is provided as material.

3. The impeller as claimed in claim 1, wherein the back wall and the molded disk are durably connected by means of adhesive bonding, especially to axially or axially-radially curved guide vanes.

4. The impeller as claimed in claim 1, wherein at least three guide vanes on the end face have partially projecting knobs which, for positioning and centering, engage in corresponding recesses of the molded disk in a positive locking manner.

5. The impeller as claimed in claim 1, wherein cyanoacrylate, epoxy or synthetic rubber is used as adhesive for the materially bonding connection of the separate components of the impeller.

6. The impeller as claimed in claim 1, wherein a separate bush is positionally fixed in a central bore of the hub by means of adhesive bonding, wherein the bush is torsionally fixed on the shaft in the installed state of the impeller.

7. The impeller as claimed in claim if wherein the hub of which is directly fastened to the shaft in a materially bonding, torsionally rigid mariner by means of adhesive bonding.

8. The impeller as claimed in claim 1, wherein the impeller is produced from a beige-colored syndiotactic polystyrol PS-S-GF30.

9. The impeller as claimed in claim 2, wherein the hub of the back wall comprises a bush which is designed as an inserted part and which is pressed on the shaft in the installed state of the impeller.

10. The impeller as claimed in claim 1, wherein the impeller includes three-dimensionally (3D) curved guide vanes.

11. A method for producing a multipart impeller as claimed in claim 1, comprising the steps that:
the back wall, inclusive of the hub and guide vanes, and also the molded disk, are produced in separate injection operations;
at least one contact zone, in a joining region between axially projecting knobs of the guide vanes and corresponding recesses of the molded disk, is wetted with an adhesive;
for achieving a materially bonding connection, the components, back wall and molded disk, are joined together and pressed;
a separate bush is inserted in the central bore of the hub and positionally fixed by means of adhesive bonding.
